(19) United States
(12) Patent Application Publication
(10) Pub. No.: US 2013/0179773 A1
(43) Pub. Date: Jul. 11, 2013

(54) METHOD FOR ONLINE EDITING AND PUBLISHING AND DEVICE THEREOF

(71) Applicant: Yu-Tai Lee, Taipei (TW)

(72) Inventor: Yu-Tai Lee, Taipei (TW)

(21) Appl. No.: 13/692,677

(22) Filed: Dec. 3, 2012

Related U.S. Application Data
(60) Provisional application No. 61/569,749, filed on Dec. 12, 2011.

(51) Int. Cl. G06F 17/24

(52) U.S. Cl. CPC G06F 17/24
USPC 715/234

(57) ABSTRACT

The present invention discloses a method for, online editing and publishing and the device thereof. The method for online editing and publishing comprises the following steps: obtaining from a storage unit or from the Internet, at least one figure with first configuration data; editing the at least one figure in an area of a web page, wherein the web page has at least one tool around the area for editing; generating a first drawing result from the editing; and publishing the first drawing result to the Internet through the web page of a website. With the present invention, the process of generating works may be simpler and faster than before; thereby the efficiency of work output and the number of works are increased.

### BACKGROUND OF THE INVENTION

1. Field of the Invention

The present invention relates to a method for editing and the device thereof. More specifically, the present invention relates to a method for online editing and publishing and the device thereof

2. Description of Related Art

In past decades, the Internet has a tremendous impact on people's daily life. It consists of millions of private, public, academic, business, and government networks, from local to global scope, that are linked by a broad array of electronic, wireless and optical networking technologies. The Internet carries an extensive range of information resources and services, such as the inter-linked hypertext documents of the World Wide Web (WWW) and the infrastructure to support email.

Now, people spend more time on the Internet than before, such as searching for information they need, doing online shopping, and surfing website they are interesting in, etc. There are tons of articles, pictures and drawings on the Internet that people can browse. For example, many people like to read the comic strip on the Internet. When a person wants to make some small changes on the comic strip, they need to download the comic strip and edit on their computer. After the editing, they have to generate a desired result and then publish the same on the website again. Many people have been entertained by the idea of publishing personal add-on works for fun. Publishing those add-on works can be quite interactive. However, many people are discouraged in their attempts to publish their person& add-on works while they have found the publishing process is complex and cumbersome. In particular, the process of downloading the comic strip and use some editing software to edit the comic strip and then generate a desired result can be very tedious and time-consuming. The undesirable process may frustrate the motivation of the person when the person has only want to make relatively small changes to the personal add-on work. To enhance the user's experience in online editing and simplify the publishing process will largely encourage people to share their thoughts, and therefore prompt the information exchange on the Internet.

In view of the foregoing, for the demand, designing a method for online editing and publishing and a device thereof to improve the user convenience has become an urgent issue for the application in the market.

### SUMMARY OF THE INVENTION

A method for online editing and publishing is disclosed, comprising: obtaining from a storage unit or from the Internet, at least one figure with first configuration data; editing the at least one figure in an area of a web page, wherein the web page has at least one tool configured around the area for editing; generating a first drawing result from the editing; and publishing the first drawing result to the Internet through the web page of a website.

A computer-readable storage medium is further provided. The computer-readable storage medium has computer-executable instructions stored therein for online editing and publishing; the computer-executable instructions when installed onto a computing device enable the computing device to perform the operations above.

A device for online editing and publishing is further provided. The device for online editing and publishing comprises a processing module, a network module, and a user interface. The network module is electrically connected with the processing module and provides a network communication for the device. The user interface is used to perform a plurality of operations; the operations comprise: obtaining from a storage unit or from the Internet, at least one figure with first configuration data; editing the at least one figure in an area of a web page, wherein the web page has at least one tool around the area for editing; generating a first drawing result; and publishing the first drawing result to the Internet through the web page of a website.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a system diagram of one embodiment of an environment in which the invention may be practiced.

FIG. 2 is a schematic view illustrating an embodiment of a user interface of the device according to the present invention.

FIG. 3 illustrates a flow chart generally showing the method for online editing and publishing in accordance with one embodiment of the present invention.

### DETAILED DESCRIPTION OF THE PREFERRED EMBODIMENTS

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

### Illustrative Operating Environment

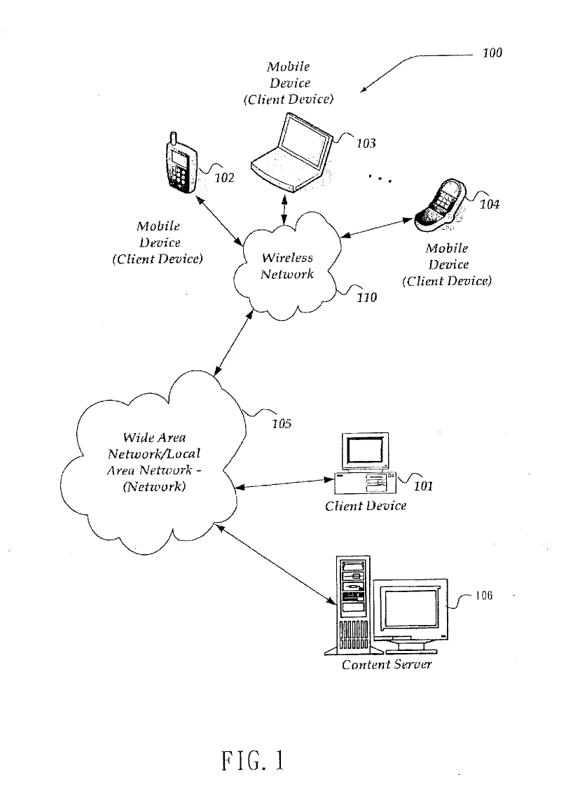

FIG. 1 shows components of one embodiment of an environment in which the invention may be practiced. Not all the components may be required to practice the invention, and variations in the arrangement and type of the components may be made without departing from the spirit or scope of the invention. As shown in FIG. 1, the system 100 includes networks that enable the communication between client and network devices or servers. A network 105 may comprise one or more local area networks (“LANs”) and/or wide area networks (“WANs”). A wireless network 110 may comprise LANs, WANs, telephony networks, or the like. The system 100 also includes a general purpose client device 101, one or more mobile devices 102-104, and a content server 106.

Generally, the mobile devices 102-104 may include virtually any portable computing device capable of receiving and sending a message over a network, such as the network 105, the wireless network 110, or the like. The mobile devices 102-104 may also be described generally as client devices that are configured to be portable. Thus, the mobile devices 102-104 may include virtually any portable computing device capable of connecting to another computing device and receiving the information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, the mobile devices 102-104 typically range widely in terms of capabilities and features.

As another example, a web-enabled mobile device may have a touch sensitive screen, a stylus, and several lines of color LCD display in which both text and graphics may be displayed. A web-enabled mobile device may include a messaging client and a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. In one embodiment, a user of the mobile device may employ the browser application to exchange text messages that include search queries and search results. A user may also employ a browser application to access additional search result content that is identified in one or more text messages.

The client device 101 may include virtually any computing device capable of communicating over a network to send and receive the information, including the search query information, the location information, the social networking information, or the like. The set of such devices may include devices that typically connect using a wired or wireless communications medium such as personal computers, multiprocessor systems, microprocessor-based or programmable consumer electronics, network PCs, or the like. The client device 101 may include a messaging system and/or an interface for sending or receiving the text messages with the mobile devices 102-104 or other client devices.

The wireless network 110 is configured to couple the mobile devices 102-104 and its components with a network 105. The wireless network 110 may include any of a variety of wireless sub-networks that may further overlay stand-alone ad-hoc networks, and the like, to provide an infrastructure-oriented connection for the mobile devices 102-104. Such sub-networks may include cellular networks, mesh networks, Wireless LAN (WLAN) networks, and the like.

The network 105 is enabled to employ any form of computer readable media for communicating the information from one electronic device to another. Also, the network 105 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, enabling the messages to be sent from one to another. Also, the communication links within LANs typically include twisted wire pairs or coaxial cables, while the communication links between the networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modern and temporary telephone link. In essence, the network 105 includes any communication method by which information may travel between the content server 106, the client device 101, and other computing devices.

The content server 106 represents a variety of content and/or other data that may be useable on the mobile devices 102-104 and/or on the client 101. Such content may include text contents, web contents, audio contents, video contents, FTP data, or the like. Data services may include, but are not limited to SMS, IM services, email services, services, web services, third-party services, audio services, video services, VOIP services, calendaring services, photo services, or the like. Devices that may operate as a content server 106 include personal computers, desktop computers, multiprocessor systems, microprocessor-based or programmable consumer electronics, network PCs, servers, and the like.

### Generalized Operation

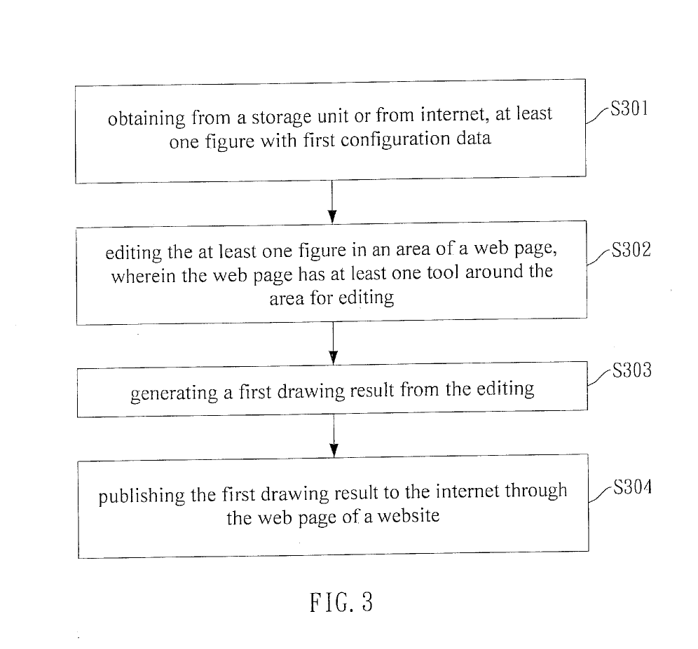

As noted herein, the exemplary embodiments are directed to a device and method for online editing and publishing, The features variously described below and elsewhere herein can be performed using the apparatus shown in FIG. 1, and can be variously implemented in the exemplary process shown in FIG. 3 and described further below.

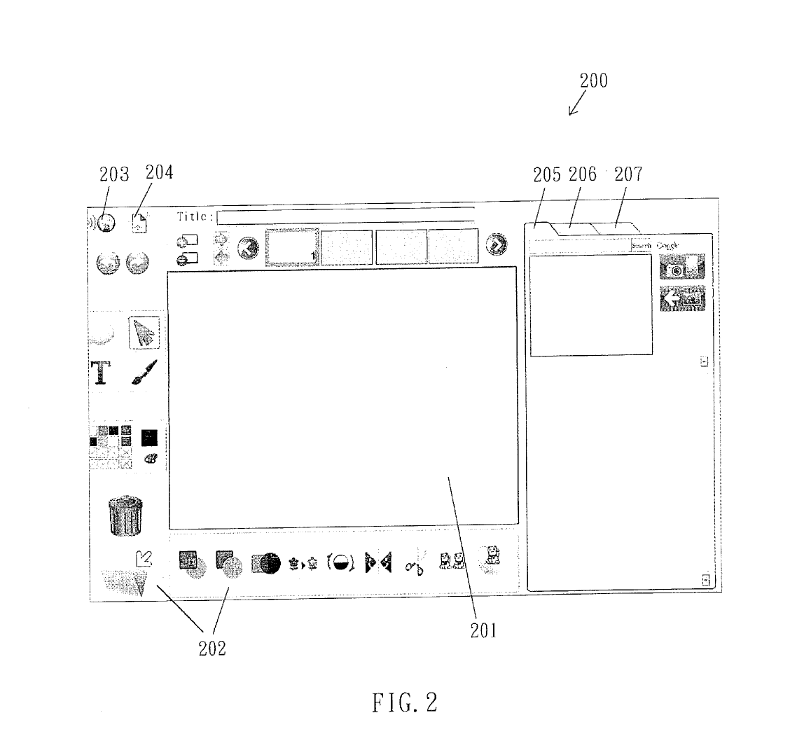

Refer to FIG. 2 as a schematic view illustrating an embodiment of a user interface of the device for online editing and publishing according to the present invention. In an exemplary embodiment, a device such as the mobile device 102, 103, 104 or the client device 101 with a processing module and a network module preferably comprise a web-based user interface 200 as shown in the FIG. 2. The web-based user interface 200 is preferably realized in a web page, and comprises a drawing area 201, tool icons 202, the Publishing icon 203, the New File icon 204 and so on. A user may click the New File icon 204 to open a new file, draw some figures in the drawing area 201 by using the tool icons 202 configured around the drawing area 201, generate a drawing result from the editing, and then click the Publishing icon 203 to publish the drawing result to the Internet.

In another exemplary embodiment, a first user may store some figures to the content server 106 in the original format. The content server 106 may generate a readable format based on the stored figures with the original format and publish it on the web page. While seeing the published figures, a second user is enabled to revise the published figures by using the tool icons 202 configured around the drawing area 201 based on the stored figures with the original format from the editing, and to generate a new drawing result. Then the second user can click the Publishing icon 203 to publish the drawing result on the Internet through the web-based user interface 200.

In another exemplary embodiment, a user may obtain some figures from a storage unit, local or remote, or from the Internet. For example, a user may click the Internet icon 205, the Stored Figures icon 206 or the My Figures icon 207 on the right top side of the web-based user interface 200, and put the key word for figure searching. The searched figures via the Stored Figures icon 206 or the My Figures icon 207 may be originally stored in the content server 106 or the mobile devices 102-104 respectively. The embodiments here are only examples for illustration but not limiting to this invention; when being actually implemented, this invention is not limited to such a manner. Then, the user may edit the searched figures or make some modifications on the searched figures by using the tool icons 202 configured around the drawing area 201, generate a new drawing result from the editing, and then click the publishing icon 203 to publish the drawing result on the Internet through the web-based user interface 200.

It is worth noting that the web-based user interface 200 may let a user use a unique identification and password, or an existing account on some websites, such as Facebook, to login. Also, the searched figures preferably comprises the first configuration data, such as a location coordinate, a size and a color of at least one element. A user may edit the searched figures and then generate a new drawing result with the second configuration data (may have different location coordinate, size and color of at least one element) compared with the first configuration data. The modified figures may preferably comprise different configuration data for the purpose of future restoration and modification.

Afterward, the user may publish the new drawing result as a compatible format to the web page on the Internet via clicking the Publishing icon 203 on the web-based user interface 200. In addition, the new drawing result may be a template for other people to make further edition or modification since the drawing result is preferably published as a common format, such as .jpg, .gif, .png and so on.

FIG. 3 illustrates operation of certain aspects of the invention and shows a logical flow chart of an exemplary process 300 that encompasses various aspects and features of the invention described herein. As shown in the chart, the method for online editing and publishing according to this invention is applied to an electronic device. The electronic device preferably comprises a processing module, a network module, a user interface for a user to perform a plurality of operations. The method for online editing and publishing comprises the following steps:

(S301) obtaining from a storage unit or from the Internet, at least one figure with first configuration data;

(S302) editing the at least one figure in an area of a web page, wherein the web page has at least one tool around the area for editing;

(S303) generating a first drawing result from the editing; and

(S304) publishing the first drawing result to the Internet through the web page of a website.

The detailed description and embodiments of method for online editing and publishing according to this invention are given above, and so unnecessary details are not given here.

To sum up, for the comic strip published on the Internet, any user/member can take the comic strip, easily revise the comic strip and publish a new drawing result to the Internet without changing the configuration data of the original figures. It means any work on the Internet to be a template; any person may develop a new work based on the template. Then, other people may develop new works based on the previous works developed by some person. As time goes by, the works will be more and more. In addition, this invention may help the rise of series works; because user/member may directly takes lots of common parts from other's work, user/member may change some specific parts needed to modify. Again, this invention make the process of generating work simpler and faster than before; thereby the efficiency of work output and the number of works are increased.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. A method for online editing and publishing, comprising:
obtaining from a storage unit or from Internet, at least one figure with first configuration data;
editing the at least one figure in an area of a web page, wherein the web page has at least one tool configured around the area for editing;
generating a first drawing result from the editing; and
publishing the first drawing result to the Internet through the web page of a website.

2. The method for online editing and publishing as claimed in claim 1, wherein the first configuration data comprises a location coordinate, a size and a color of at least one element.

3. The method for online editing and publishing as claimed in claim 1, further comprising:
storing the at least one figure with the first configuration data in the storage unit.

4. The method for online editing and publishing as claimed in claim 1, further comprising:
storing the first drawing result with second configuration data in the storage unit;
wherein the second configuration data comprises a location coordinate, a size and a color of at least one element.

5. The method for online editing and publishing as claimed in claim 4, further comprising:
editing the first drawing result in the area of the web page;
generating a second drawing result from the editing; and
publishing the second drawing result to the Internet through the web page of the website.

6. The method for online editing and publishing as claimed in claim 1, further comprising:
editing the at least one figure in the area of the web page to generate a template; and
storing the template with second configuration data in the storage unit;
wherein the second configuration data comprises a location coordinate, a size and a color of at least one element.

7. The method for online editing and publishing as claimed in claim 1, further comprising:
publishing the first drawing result to the Internet as a compatible format of the web page.

8. A computer-readable storage medium having computer-executable instructions stored therein for online editing and publishing, the computer-executable instructions when installed onto a computing device enabling the computing device to perform the method of claim 1.

9. A device for online editing and publishing, comprising:
a processing module;
a network module being electrically connected with the processing module and providing a network communication for the device; and
a user interface;
wherein the processing module is configured for a user to perform a plurality of operations through the user interface, the operations comprising:
obtaining from a storage unit or from Internet, at least one figure with first configuration data;
editing the at least one figure in an area of a web page, wherein the web page has at least one tool configured around the area for editing;
generating a first drawing result from the editing; and
publishing the first drawing result to the Internet through the web page of a website.

10. The device for online editing and publishing as claimed in claim 9, wherein the first configuration data comprises a location coordinate, a size and a color of at least one element.

11. The device for online editing and publishing as claimed in claim 9, the operations further comprising:
storing the at least one figure with the first configuration data in the storage unit.

12. The device for online editing and publishing as claimed in claim 9, the operations further comprising:
storing the first drawing result with second configuration data in the storage unit;
wherein the second configuration data comprises a location coordinate, a size and a color of at least one element.

13. The device for online editing and publishing as claimed in claim 12, the operations further comprising:
editing the first drawing result in the area of the web page;
generating a second drawing result from the editing; and
publishing the second drawing result to the Internet through the web page of the website.

14. The device for online editing and publishing as claimed in claim 9, the operations further comprising:
editing the at least one figure in the area of the web page to generate a template; and
storing the template with second configuration data in the storage unit;
wherein the second configuration data comprises a location coordinate, a size and a color of at least one element.

15. The device for online editing and publishing as claimed in claim 9, the operations further comprising:
publishing the first drawing result to the Internet as a compatible format of the web page.
